(19) United States
(12) Patent Application Publication
(10) Pub. No.: US 2014/0127664 A1
(43) Pub. Date: May 8, 2014

(54) Real-time Computerized Interactive Text Memorization Method and System

(71) Applicant: Kevin Smith, Westport, CT (US)

(72) Inventor: Kevin Smith, Westport, CT (US)

(73) Assignee: Mytheaterapps.com, Westport, CT (US)

(21) Appl. No.: 13/720,503

(22) Filed: Dec. 19, 2012

Related U.S. Application Data
(60) Provisional application No. 61/578,138, filed on Dec. 20, 2011.

(51) Int. Cl. G09B 5/06

(52) U.S. Cl. CPC G09B 5/065
USPC 434/308

(57) ABSTRACT

Method and system for real-time computerized interactive text memorization. The real-time computerized interactive text memorization aids in the memorization of large amounts of text that contain an established sequence and flow that must be adhered to during the recitation of the text by a speaker. The present disclosure utilizes a data parser, a character selection function, a text to speech engine and a voice recorder to provide visual text displays, digitized and recorded audio playback and digitized and recorded audio annotation. Data is uploaded into the system where they are then scanned by the data parser and prepared to create the various audio/visual elements needed for memorization by the user. The data parser then searches and separates text-based data into its unique theatrical or playwriting character based components. A character selection function of the present disclosure allows a user to select as many characters s desired from the uploaded parsed data. A text to speech engine is utilized as a means to audibly reproduce any of the parsed components created by the data parser. The voice recorder function allows a user to record audio clips that can be associated to the parsed components created by the data parser in the system. The playlist creation element will associate either start points for the text to the speech engine or recorded audio samples from the voice recorder function to those various components identified by the data parser. From the generated playlist the learner can then choose that portion of the text which requires their attention in order to prepare for the upcoming recitation. The data playback function allows for the reproduction of the parsed text and start points or audio samples in tandem at variable rates using both recorded audio and multiple text to speech voices as determined by the learner. The annotation and text editing element provides the learner with the ability to make text changes as needed which are then incorporated into the audio and text reproduction in real-time.

### CROSS-REFERENCE TO RELATED APPLICATIONS

This Application claims priority from Provisional Application No. 61/578,138 filed on Dec. 20, 2011

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The current invention generally relates to systems and methods utilized for audiovisual memorization.

### BACKGROUND OF THE INVENTION

The objective of the present invention is to aid in the memorization of large amounts of text that contain an established sequence and flow that must be adhered to during the recitation of said text by a speaker. In these cases the memorization of the text alone is not sufficient to provide the basis for an accurate presentation of the prescribed content. Memorization of the sequence and flow of the content is also critical to the desired outcome, often as important as the memorization of the words themselves. The relevant memorization efforts typically result in public recitations by speakers and include events such as public speeches, sermons, business presentations, public and private ceremonies, film and television productions and theatrical class work and presentations. This event listing is inclusive but not exhaustive.

Memorization techniques for large amounts of text often take two forms, aural and visual. Aural learners who memorize large amounts of text rely on hearing the text in a repetitive manner in order to commit the text and the sequence to memory. Visual learners, on the other hand, create associations based on the placement and sequence of the text in relationship to other visual elements within the source content.

Text to speech, voice recording and text parsing have been widely used in the art for reproducing text in a continuous linear string. However, none of these methods for text reproduction provide the flexibility or the benefit of sequencing or modal operations for memorization purposes, particularly for memorization that requires subsequent recitation.

Prior to the present invention, aural learners used traditional voice recording devices to record the required text and listen to it in a linear fashion. This often required the use of a dedicated recording device. Moreover, this method provides little or no flexibility to sequence the playback of the text based on where the learner is in the memorization cycle. It also fails to leverage existing electronic devices in use by the learner. The inefficient nature of this solution results in the learner manually recording each segment of text and requiring the same of others if they are participating in a public recitation.

Similarly, prior to the present invention, visual learners had to use physical written or printed text as the source document for their memorization. This required the use of a dedicated physical document that would be manually marked up with highlights so that the learner could visually identify their portion of a text sequence. That portion was then permanently marked, prohibiting the re-use of that text in other applications.

Several computer-based memorization solutions also fail to account for the dynamic nature of the text being memorized, requiring complete reconstruction of any audio or visual aids every time a substantive change of the memorized text is required. These and other inefficiencies exist in prior methods and systems for text memorization.

The present invention involves a real-time, interactive text memorization method and system. The system comprises a data parser, a character selection function, a text to speech engine, a voice recorder, a data playback function, a playlist creation element, an annotation creation element and a text editor.

The data parser of the present invention searches and separates text-based data into unique, character based components .The character selection function then allows a user to select one or more characters from the parsed data for whom the user would like to memorize relevant data. The playlist creation element is enabled to associate either text to speech start points or recorded audio samples to those various components identified by the data parser. The data playback function is enabled to allow for the reproduction of the parsed text and audio start points or samples in tandem at variable rates using both recorded audio and multiple text to speech voices as determined by the learner. In conjunction with the audio playback, the associated text is written to the screen and optionally highlighted, giving aural and visual learners the ability to listen to and read the text. This combination of flexible and user-controlled audio and text reproduction facilitates the memorization of text data by a user.

The flexibility delivered by the text parser allows the learner to navigate the text using system generated and customer designated playlists. The learner can then choose that portion of the text which requires their attention in order to prepare for the upcoming recitation. The display of text also provides an automated highlight function that aids visual learners without the attendant manual process that permanently alters the source document. Additional flexibility is provided through the onboard text editing function, which gives the learner the ability to make text changes as needed which are then incorporated into the audio and text reproduction in real-time. The annotation system delivers an additional tool that aids the learner through the creation of various recorded or text to speech notes. These annotations can be associated with specific portions of the text to be memorized and inserted at that point during playback. These capabilities are delivered without the need for the learner to acquire a unique device or apparatus designed only for this purpose.

### SUMMARY OF THE INVENTION

This invention relates to computer systems with speech capabilities and particularly to a real-time computerized interactive text memorization method and system which utilizes a data parser, a character selection function, a text to speech engine and a voice recorder to provide visual text displays, digitized and recorded audio playback and digitized and recorded audio annotation.

### BRIEF DESCRIPTION OF THE DRAWINGS

The subject matter, which is regarded as the invention, is particularly pointed out and distinctly claimed in the claims at the conclusion of the specification. The foregoing and its features, along with advantages of the invention will be apparent from the following detailed description taken in conjunction with the accompanying drawings:

FIG. 1 is a diagram that accurately depicts the over-all audio visual memorization system including all individual components within the system in accordance with one or more embodiments of the present invention.

FIGS. 2A-FIGS. 2D accurately depict a detailed schematic view of the computerized interactive memorization system broken up onto four sheets arranged side-by-side from left to right in accordance with one or more embodiments of the present invention.

### DETAILED DESCRIPTION OF THE INVENTION

It should be understood that this embodiment is only one example of the many possible forms that the invention can use. In general, statements made in the specification of the present application do not necessarily limit any of the claims of the invention. Moreover, some statements may apply to some inventive features but not to others. In general, unless otherwise indicated, singular statements may be in the plural and vice-versa with no loss of generality.

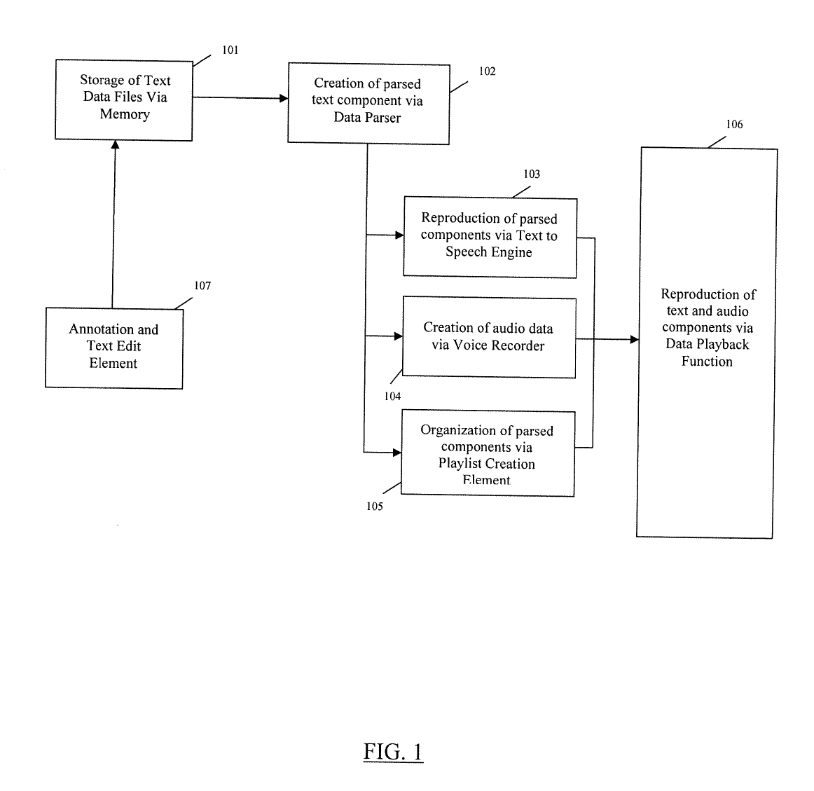

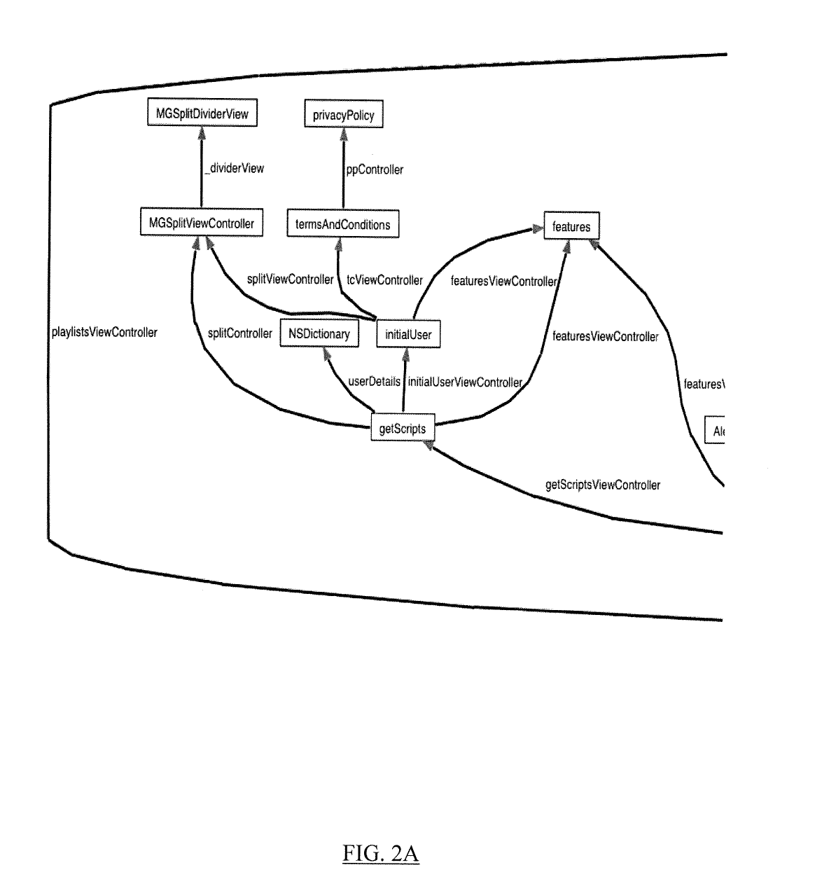

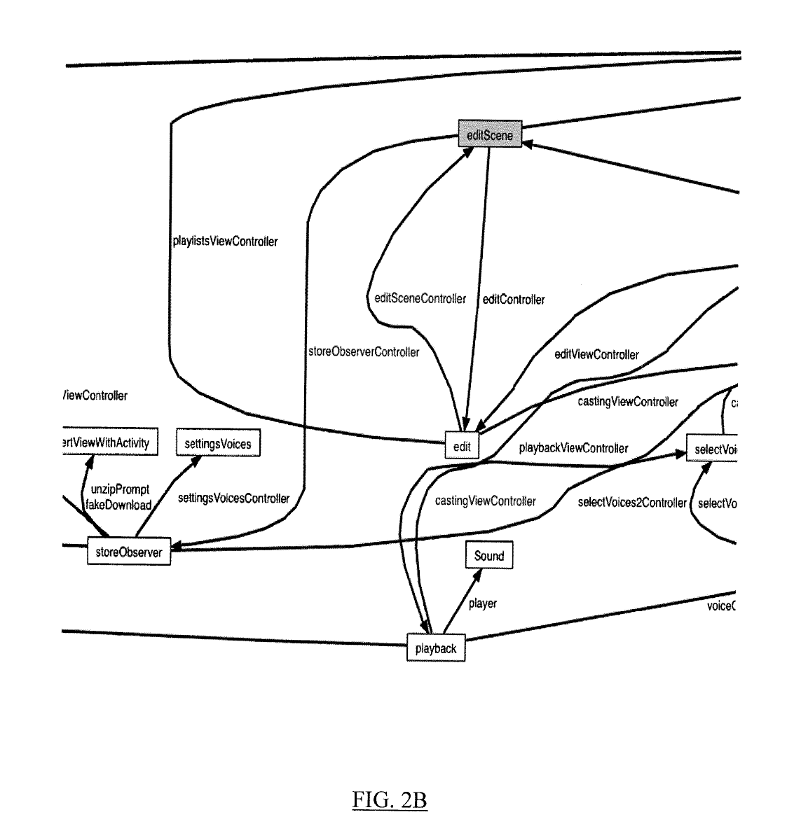

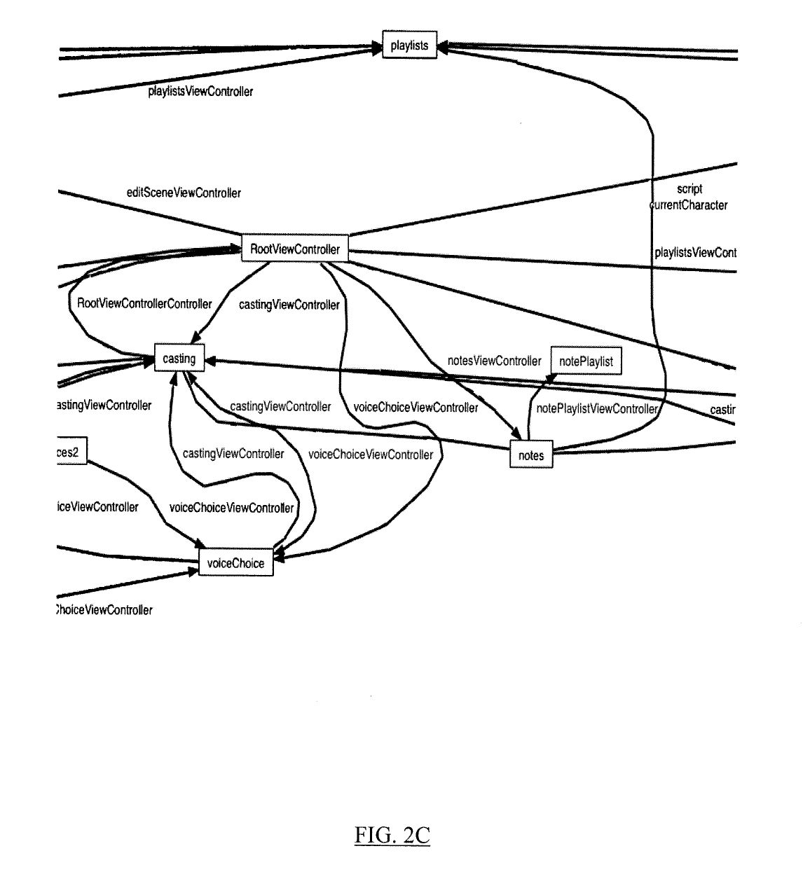

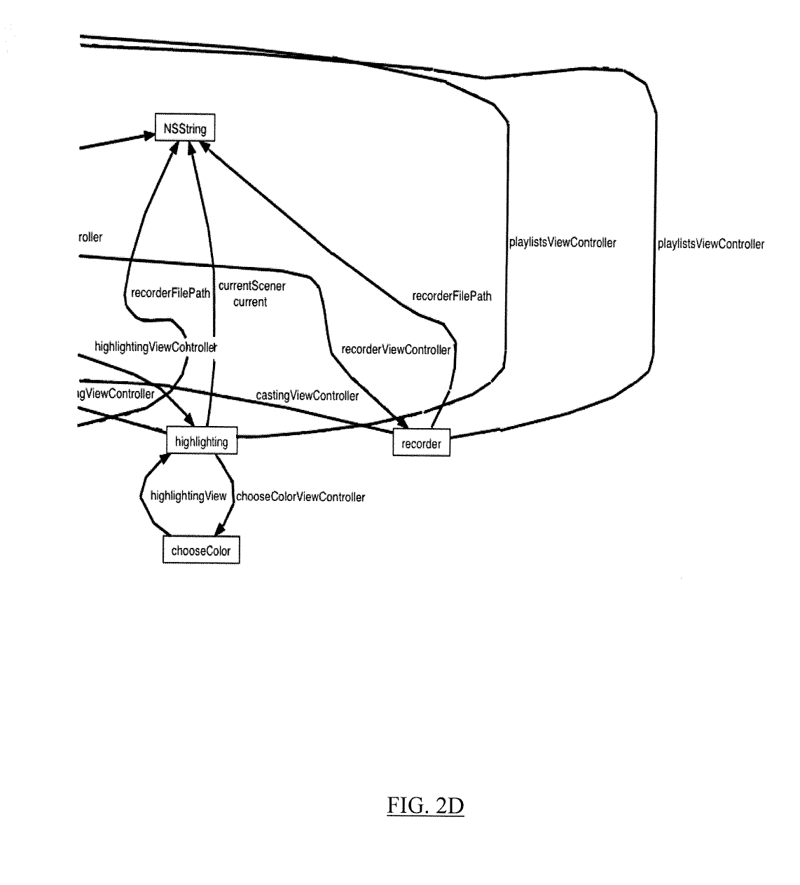

The invention presented in FIG. 1, achieves a real-time computerized interactive text memorization method and system. The invention utilizes a text parser, a character selection function, a text to speech engine and a voice recorder to provide visual text displays, digitized and recorded audio playback and digitized and recorded audio annotation. The various elements that create the audio/visual memorization system can be divided into a data parser, a character selection function, a text to speech engine, a voice recorder, a data playback function, a playlist creation element, an annotation creation element and a text editor element generally.

### Uploading Data Files

The system and method within FIG. 1 begins through the upload of a text data into the system. Text data generally refers to pre-formatted text files containing the information that a user is seeking to memorize. Text files can include files formatted in Microsoft® Word® (.doc) and Adobe® Portable Document Format (.pdf), but are not limited to these file formats.

The data files in text format can be uploaded for access either into local or cloud-based storage 101. Local storage can be physical memory, including computers and servers that are connected or incorporated into any given device that accesses the system. Cloud-based storage requires that the system access the uploaded data files from storage that is remotely connected, usually through a wired or wireless network connection.

### Parsing Data Files for Preparation of Real-Time Audio/Visual Memorization

Once uploaded into the system, data files are scanned by the Data Parser 102 and prepared to create the various audio/visual elements needed for memorization by the user. The Data Parser 102 searches and separates text-based data into its unique, theatrical or playwriting character based components. These components generally are parsed based on the characters, noting the unique sections of the data files in order to create the parsed components. These components can be defined by identified speakers (either characters in a theatrical production or presenters within a speech); but can also identify different sections based on grammatical rules such as paragraph, characters, or lines.

In a preferred embodiment of the present invention, the data files that are uploaded onto the system follow standard theatrical and playwriting conventions. The data parser is enabled to go through this text file and identify the various character names, dialogue associated with each character name, stage directions that are general to the script and specific to different characters, act and scene designations and parse the data into various categories based on the above-mentioned characteristics. The parsed data is then stored in a SQLite database file.

This method of parsing allows a user to populate a playlist, using the playlist creation element, by selecting a particular character or several characters from the data source.

The flexibility delivered by the Data Parser 102 allows a learner to navigate through large amounts of text simply by using a system generated and customer designated playlist. The learner can choose to narrow his/her focus and select only that portion of the text which requires their attention in order to prepare for an upcoming recitation.

### Character Selection Function

It is anticipated that a user or learner may be interested in data associated with one or more than one character in the parsed data. The character selection function of the present invention allows a user to select as many characters as desired from the parsed data.

### Text to Speech Engine

A Text to Speech Engine 103 is utilized in order to audibly reproduce any of the parsed components created by the Data Parser 102. The engine can either be a custom built element or a licensed engine that is incorporated into the system. Once parsed sections of the data files are identified, each section can be associated to the text to speech engine, either directly via the voice recorder function or to a particular voice pre-existing within the engine, in order to audibly reproduce the parsed component when initiated through the data playback function.

In one embodiment of the present invention, the text to speech engine is licensed from the Acapela Group. The text to speech engine allows a learner to choose from 19 different voices embedded within engine and assign a different voice to any section of the parsed data selected by the user. The pre-existing voices are differentiated on the basis of gender, accent, dialect, mood, age, etc.

### Voice Recorder Function

The Voice Recorder Function 104 allows a user to record audio clips that can be associated to the parsed components created by the Data Parser 102 in the system. The recorder function may also be used for the addition of voice notes that are later utilized by the annotation element described below. Such “notes” would be assigned to a particular parsed component of the data file and placed within the playback order found within the data playback function described below.

The voice recorder function further allows a user to record parsed data associated with one or many theatrical characters in the user's voice. Similar recording of specific sections of the parsed data can also be done in the voice of other individuals. In one embodiment of the invention, during a rehearsal of a particular theatrical piece, the voice recorder of the present invention is used to record several different sections of the parsed data in the voices of different participants of the rehearsal. These recordings are stored within the SQLite database and tagged to the parsed data, such that a playback of these sections using the Playback Function will render these sections in the recorded voices.

### Playlist Creation Element

The Playlist Creation Element 105 will associate either start points for the Text to Speech Engine 103 or recorded audio samples from Voice Recorder Function 104 to those various components identified by the Data Parser 102. From this generated playlist the learner can then choose that portion of the text which requires their attention in order to prepare for the upcoming recitation.

In one embodiment of the present invention, the Playlist Creation Element provides a user with the following four different options to choose from: Just Me; Just My Cues; Me and My Cues; and Full Scene. The user may navigate through these options to differentially select only that portion of the text that they seek to memorize a any given time

### Data Playback Function

The Data Playback Function 106 allows for the reproduction of the parsed text and start points or audio samples in tandem at variable rates using both recorded audio and multiple text to speech voices as determined by the learner. In conjunction with the audio playback, the associated text is delivered with optional highlight coloring to the screen, giving aural and visual learners the ability to listen to and read the text. This combination of audio and text reproduction facilitates the memorization of text data by a user.

The Data Playback Function 106 carries a set of traditional playback functions commonly associated with audio reproduction systems. This includes play, pause, stop, and variable rated controls for adjusting the rate of a reproduction of the audio associated with the parsed components. The Data Playback Function 106 also allows for a user to reproduce certain parsed components or to stop at the end of each one. The playback functions can also create filters in order to reproduce certain parse components or the start points associated with those components. An example would be to set the filter of the playback function to only reproduce those components associated with a particular speaker.

Annotation and Text Editing element

Additional flexibility is provided through the Annotation and Text Editing Element 107, which gives the learner the ability to make text changes as needed which are then incorporated into the audio and text reproduction in real-time. The Annotation and Text Editing Element 107 delivers an additional tool that aids the learner through the creation of various recorded or text to speech notes. These annotations can be associated with specific portions of the text to be memorized and inserted at that point during playback.

Annotations allow for the creation of additional notes that aid a user in the memorization of a data file. An annotation may be incorporated in the Data Playback Function 106 at the user's discretion, and can be associated to a parsed component of the data file. The Annotation and Text Editing Element 107 allows for changes to the data file in order to create new or alter existing parsed components that can be associated and reproduced within the system. This allows for real-time modification of the files and faster memorization by the user in the event of any changes that are required. It also allows a learner to make any required changes to the uploaded text file to conform the data to the standard theatrical conventions. It should be emphasized that the above-described embodiment of the invention is merely a possible example of implementations set forth for a clear understanding of the principles of the invention. Variations and modifications may be made to the above-described embodiment of the invention without departing from the spirit and principles of the invention. All such modifications and variations are intended to be included herein within the scope of the invention and protected by the following claims.

What is claimed is:

1. An interactive text memorization system comprising: a data parser, a character selection function, a text to speech engine, a voice recorder, a data playback function, a playlist creation element, an annotation creation element, and a text editor, wherein said data parser divides data files into uniquely identified component parts and associates audio and text data created through the text to speech engine, the voice recorder, and the annotation creation element and enables the playlist creation element to provide playlist options for each character selected using the character selection function, for the purpose of simultaneous reproduction through the data playback function.

2. The interactive text memorization system of claim 1, wherein the data files follow standard theatrical and playwriting character conventions.

3. The interactive text memorization system of claim 1, wherein the data parser stores the data files in a SQLite database file.

4. The interactive text memorization system of claim 1, wherein the data parser is enabled to identify and divide data files based on theatrical character names and dialogue associated with the character names.

5. The interactive text memorization system of claim 1, wherein the data parser is enabled to identify and divide data files based on theatrical stage directions and act and scene designations.

6. The interactive text memorization system of claim 1, wherein the character selection function enables a user to select only data associated with desired theatrical characters for audio visual playback.

7. The interactive text memorization system of claim 1, wherein the playlist creation element enables a user to navigate through the parsed data files and select one or more than one theatrical character based text for sequential audio visual reproduction.

8. The interactive text memorization system of claim 1, wherein the text to speech engine allows a user to assign a gender specific voice to the uniquely identified component parts of the text data.

9. The interactive text memorization system of claim 1, wherein the text to speech engine allows a user to assign a mood specific voice to the uniquely identified component parts of the text data.

10. The interactive text memorization system of claim 1, wherein the text to speech engine allows a user to assign a dialect specific voice to the uniquely identified component parts of the text data.

11. The interactive text memorization system of claim 1, wherein the voice recorder function enables a user to record the uniquely identified component parts of the text data in the voice of one or many users.

12. The interactive text memorization system of claim 1, wherein the playlist creation element enables a user to audio visually playback the data selectively in a sequential manner.

13. The interactive text memorization system of claim 1, wherein the data playback function enables the reproduction of the parsed text in tandem at variable rates using both recorded audio and multiple text to speech voices.

14. The interactive text memorization system of claim 1, wherein the data playback function enables the reproduction of the visual data with optional highlight coloring to the screen.

15. An interactive text memorization system comprising an electronic device, a data parser, a character selection function, a text to speech engine, a voice recorder, a data playback function, a playlist creation element, an annotation creation element, and a text editor, wherein desired text files downloaded onto the electronic device are parsed by the data parser into unique theatrical character based sections, gender and accent enabled voice is assigned by the text to speech engine and the voice recorder function to each character based section, personalized notes are associated to the character based sections by the annotation creation element, uploaded text files are modified by the text editor, character based selection of data for audio and visual playback is enabled by the character selection function, and the selected character based section is reproduced aurally and visually with highlights by the data playback function.

16. The interactive memorization system of claim 15, wherein the electronic device is a computer.

17. The interactive memorization system of claim 15, wherein the electronic device is a smart phone.

18. The interactive memorization system of claim 15, wherein the electronic device is a tablet.

19. A method for interactive text memorization, comprising parsing of standard theatrical text data into uniquely identifiable component data parts, associating desired audio playback characteristics with said data parts, selectively annotating said data parts, populating a playlist of desired data parts, and simultaneously reproducing the desired data parts in audio and video formats.
